(19) United States
(12) Patent Application Publication
(10) Pub. No.: US 2007/0018933 A1
(43) Pub. Date: Jan. 25, 2007

(54) Driving circuit for display device and display device having the same

(75) Inventor: Jung-Woo Lee, Yongin-si (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/397,649

(22) Filed: Apr. 3, 2006

(30) Foreign Application Priority Data
Jul. 12, 2005 (KR) 10-2005-0062736

(51) Int. Cl. G09G 3/36

(52) U.S. Cl. 345/98

(57) ABSTRACT

A driving circuit and a display device including the driving circuit are presented. The driving circuit has a controller, a driving voltage generator, and a gate signal generator. The driving voltage generator generates a first voltage; the controller receives the first voltage and generates a second voltage according to an ambient temperature; and the gate signal generator generates a third voltage based on the second voltage. Accordingly, since only the gate-on voltage Von is designed to change, problems associated with a change in the driving voltage AVDD, such as deterioration of image quality, an increase in power consumption, an increase in operating temperature of the drivers, and shortening of the lifespan of a product, can be reduced or eliminated.

### CROSS-REFERENCE TO RELATED APPLICATION

This patent application claims priority from Korean Patent Application No. 2005-0062736 filed on Jul. 12, 2005, the content of which is incorporated by reference herein in its entirety.

### BACKGROUND OF THE INVENTION

(a) Field of the Invention

The present invention relates to a driving circuit for a display device and a display device having the driving circuit.

(b) Description of the Related Art

Recently, as a substitute for a heavy and large cathode ray tube (CRT), flat display devices such as an organic light emitting diode (OLED) display, a plasma display panel (PDP), and a liquid crystal display (LCD) have been actively developed.

Some of the flat display devices, for example the LCD and the OLED displays, include a panel provided with pixels including switching devices and display signal lines, a gate driver for transmitting gate signals to gate lines among the display signal lines to turn on/off the switching devices of the pixels, a gray voltage generator for generating a plurality of gray voltages, a data driver for applying data voltages to data lines among the display signal lines, and a signal controller for controlling the components.

In addition, the display device includes a DC/DC converter and a charge pump circuit. The DC/DC converter supplies the driving voltage, and the charge pump circuit generates gate-on and gate-off voltages by using the driving voltage. In addition, the gray voltage generator generates required gray voltages by using the driving voltage.

In some cases, the gate driver may be integrated with switching devices in the display panel assembly. The gate driver is constructed with a plurality of transistors, which are a type of a semiconductor device whose characteristics change depending on temperature. For example, as the temperature is lowered, the threshold voltage increases. In this case, the intensity of the driving voltage generated in the DC/DC converter increases in order to increase an absolute value of the gate signals generated in a charge pump circuit, so that the switching devices of the pixels can be controlled.

However, if the driving voltage increases, the gray voltage generator and other driving circuits to which the driving signals are applied are affected. Therefore, the image quality, power consumption, and the operating temperature of the driving circuits may change as a result of the increase in the driving voltage, shortening the lifespan of a product.

### SUMMARY OF THE INVENTION

The invention provides a driving circuit of a display device capable of separately controlling the gate-on voltage and a display device having the driving circuit.

According to an aspect of the present invention, there is provided a driving circuit of a display device having a plurality of pixels each including a switching device. The driving circuit includes a driving voltage generator, a controller, and a gate signal generator. The driving voltage generator generates a first voltage, the controller receives the first voltage and generates a second voltage according to an ambient temperature, and a gate signal generator generates a third voltage based on the second voltage.

The second voltage may be higher than the first voltage if the ambient temperature is lower than a predetermined temperature, and it may be lower than the first voltage if the ambient temperature is higher than the predetermined temperature.

The controller may include a transistor having first, second, and third terminals; a first resister connected between the first terminal and the first voltage; a power supply voltage, a diode, and a second resister electrically connected in series between a ground voltage and the second terminal; and a third resister electrically connected between the third terminal and the ground voltage.

Further, the transistor may be a BJT (bipolar junction transistor). Still further, the gate signal generator may generate a fourth voltage, wherein the third voltage turns on the switching device, and the fourth voltage turns off the switching device.

According to another aspect of the present invention, there is provided a display device having a plurality of pixels including a switching device. The display device includes a driving voltage generator, a controller, a gate signal generator, and a gate driver. The driving voltage generator generates a first voltage, the controller receives the first voltage and generates a second voltage according to an ambient temperature, and the gate signal generator generates a third voltage based on the second voltage. The gate driver receives the third voltage and applies the third voltage to the switching device.

In the above aspect of the present invention, the second voltage may be higher than the first voltage if the ambient temperature is lower than a predetermined temperature. On the other hand, the second voltage may be lower than the first voltage if the ambient temperature is higher than the predetermined temperature.

In addition, the controller may include a transistor having first to third terminals; a first resistor electrically connected between the first terminal and the first voltage; a power supply voltage, a diode, and a second resister electrically connected in series between a ground voltage and the second terminal; and a third resister electrically connected between the third terminal and the ground voltage.

Further, the transistor may be a BJT, and the gate driver may be integrated in the display device. Still further, the driving circuit may include a gray voltage generator for generating a plurality of gray voltage based on the first voltage.

### BRIEF DESCRIPTION OF THE DRAWINGS

The above and other features and advantages of the present invention will become more apparent by describing exemplary embodiments thereof in detail with reference to the attached drawings in which:

FIG. 1 is a block diagram showing a liquid crystal display (LCD) device according to an embodiment of the present invention;

FIG. 2 is an equivalent circuit diagram showing a pixel of an LCD in FIG. 1;

FIG. 3 is a circuit diagram showing an example of a controller shown in FIG. 1;

FIG. 4 is a circuit diagram showing an example of a gate signal generator shown in FIG. 1; and

FIG. 5 is a graphical view showing an intensity of a control voltage according to a temperature.

### DETAILED DESCRIPTION OF THE EMBODIMENTS

Hereinafter, exemplary embodiments of the present invention will be described in detail with reference to the attached drawings such that the present invention can be easily put into practice by those skilled in the art.

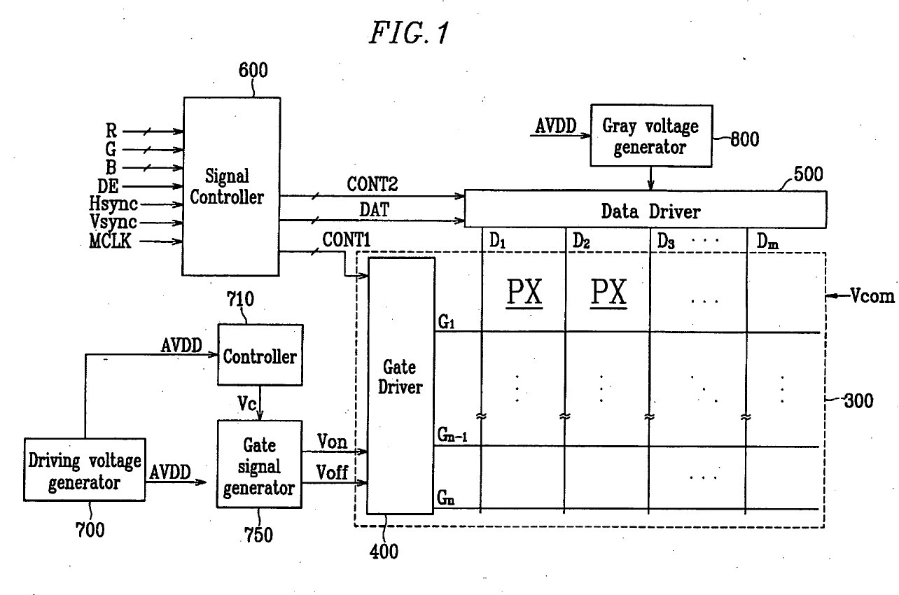

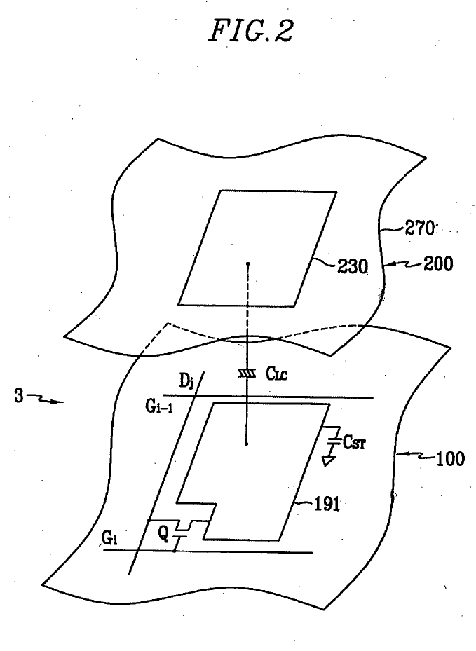

A display device according to an embodiment of the present invention will be described in detail with reference to FIGS. 1 and 2. Although a liquid crystal display device is used as an example of the display device in the embodiment, it is understood that the invention may be adapted for other types of a display device.

FIG. 1 is a block diagram showing the liquid crystal display (LCD) device according to an embodiment of the present invention, and FIG. 2 is an equivalent circuit diagram showing a pixel of the LCD device shown in FIG. 1. As shown in FIG. 1, the LCD device includes a liquid crystal display (LCD) panel assembly 300, a gate driver 400 and a data driver 500 electrically connected to the LCD panel assembly 300, a gray voltage generator 800 electrically connected to the data driver 500, and a signal controller 600 for controlling the gate driver 400, the data driver 500, and the gray voltage generator 800.

The LCD panel assembly 300 is electrically connected to a plurality of signal lines G₁ to Gₙ and D₁ to Dₘ, and includes a plurality of pixels PX arranged substantially in a matrix. Further, as shown in FIG. 2, the LCD panel assembly 300 includes lower and upper substrates 100 and 200 positioned substantially parallel to each other with a liquid crystal layer 3 interposed between the lower and upper substrates 100 and 200.

The signal lines G₁ to Gₙ and D₁ to Dₘ include a plurality of gate lines G₁ to Gₙ for transmitting gate signals (also, referred to as “scan signals”) and a plurality of data lines D₁ to Dₘ for transmitting data signals. The gate lines G₁ to Gₙ extend parallel to each other in a first direction, and the data lines D₁ to Dₘ extend parallel to each other in a second direction that is substantially perpendicular to the first direction.

Each of the pixels PX, for example, electrically connected to the i-th gate line Gᵢ (i=1, 2, . . . , n) and the j-th data line Dⱼ (j=1, 2, . . . , m), includes a switching device Q electrically connected to the signal lines Gᵢ and Dⱼ, a liquid crystal capacitor C_{LC} electrically connected to the switching element Q, and a storage capacitor C_{ST}. The storage capacitor C_{ST} may be omitted if it is not needed.

The switching element Q is a three-terminal device disposed on the lower substrate 100. Control and input terminals of the switching element Q are electrically connected to the gate and data lines Gᵢ and Dⱼ, respectively, and an output terminal of the switching device Q is electrically connected to the liquid crystal capacitor C_{LC} and the storage capacitor C_{ST}.

Two terminals of the liquid crystal capacitor C_{LC} are a pixel electrode 191 of the lower substrate 100 and a common electrode 270 of the upper substrate 200. The liquid crystal layer 3 interposed between the two electrodes 191 and 270 serves as a dielectric member. The pixel electrode 191 is electrically connected to the switching element Q. The common electrode 270 covers substantially the entire surface of the upper substrate 200 and receives a common voltage V_{com}. In some alternative embodiments, both the pixel electrode 191 and the common electrode 270, which may be shaped as bars or stripes, for example, are provided on the lower substrate 100.

The storage capacitor C_{ST} having an auxiliary function for the liquid crystal capacitor C_{LC} is constructed by overlapping the pixel electrode 191 and a separate signal line (not shown) provided on the lower substrate 100 and interposing an insulator between the pixel electrode 191 and the separate signal line. A predetermined voltage such as a common voltage V_{com} is applied to the separate signal line. Alternatively, the storage capacitor C_{ST} may be constructed by overlapping the pixel electrode 191 and a front gate line disposed on the pixel electrode 191. In this alternative embodiment, an insulator is positioned between the pixel electrode 191 and the front gate line.

Generally, in a color display, each pixel PX uniquely represents one of three primary colors such as red, green, and blue (spatial division) or sequentially represents the three primary colors in time (temporal division), thereby obtaining a desired color. FIG. 2 shows an example of the spatial division in which each pixel PX includes a color filter 230 representing one of the three primary colors in an area of the upper substrate 200 that overlaps the pixel electrode 191. Alternatively, the color filter 230 is provided on or under the pixel electrode 191 on the lower substrate 100.

At least one polarizer (not shown) for polarizing light is attached to an outer surface of the lower and upper substrates 100 and 200 of the LCD panel assembly 300.

Returning to FIG. 1, the driving voltage generator 700 generates a driving voltage AVDD and applies the driving voltage AVDD to the controller 710 and the gray voltage generator 800.

The gray voltage generator 800 receives the driving voltage AVDD and generates two pairs of gray voltage sets or reference gray voltage sets associated with transmittance of the pixels PX. One of the two pairs of gray voltage sets or reference gray voltage sets has a positive value with reference to the common voltage V_{com}, and the other has a negative value with reference to the common voltage V_{com}.

The gate driver 400 is integrated in the LCD panel assembly 300 and electrically connected to the gate lines G₁ to Gₙ of the LCD panel assembly 300 to apply gate signals generated in a combination of a gate-on voltage Vₒₙ and a gate-off voltage V_{off} to the gate lines G₁ to Gₙ, respectively.

The data driver 500 is electrically connected to the data lines D₁ to Dₘ of the LCDpanel assembly 300 to select the gray voltage transmitted from the gray voltage generator 800 and to apply the selected gray voltage as a data signal to the data lines D₁ to Dₘ. However, in a case where the gray voltage generator 800 provides a reference gray voltage associated with not all the grays but only with a predetermined number of grays, the data driver 500 divides the reference gray voltage to generate gray voltages for all the grays and selects the data signals among the generated gray voltages.

The signal controller 600 controls the gate driver 400, the data driver 500, and the like.

Each of the driving circuits 500, 600, and 800 excluding the gate driver 400 may be mounted in the form of at least one IC chip on the LCD panel assembly 300. Alternatively, each of the driving circuits 500, 600, and 800 may be attached to a flexible printed circuit (FPC) film (not shown) such that the combination of the driving circuits 500, 600, and 800may then attached to the LCD panel assembly 300 in the form of a tape carrier package (TCP). As yet another alternative, the driving circuits 500, 600, and 800 may be mounted on a separate printed circuit board (PCB). In some embodiments, the driving circuits 500, 600, and 800 may be integrated with the signal lines G₁ to Gₙ and D₁ to Dₘ and the thin film transistor switching elements Q in the LCD panel assembly 300, or may be integrated into a single chip. In the single-chip embodiment, at least one of the driving circuits 500, 600, and 800 or at least one circuit element forming the driving circuits 500, 600 and 800 may be disposed outside the single chip.

The operation of the LCD device will be now described in detail with reference to FIG. 1.

The signal controller 600 receives input image signals R, G, and B and input control signals for controlling display thereof from an external graphic controller (not shown). Examples of the input control signals include a vertical synchronization signal Vsync, a horizontal synchronization signal Hsync, a main clock signal MCLK, and a data enable signal DE.

After generating gate control signals CONT1 and data control signals CONT2 and processing the image signals R, G, and B to be suitable for the operation of the LCD panel assembly 300 in response to the input control signals, the signal controller 600 provides the gate control signals CONT1 to the gate driver 400, and the processed image signals DAT and the data control signals CONT2 to the data driver 500.

The gate control signals CONT1 include a vertical synchronization start signal STV for informing the gate driver of a start of a frame, a gate clock signal CPV for controlling an output time of the gate-on voltage Von, and an output enable signal OE for defining a width of the gate-on voltage Von.

The data control signals CONT2 include a horizontal synchronization start signal STH for informing the data driver 500 of a start of a horizontal period, a load signal LOAD or TP for instructing the data driver 500 to apply the appropriate data voltages to the data lines D₁-Dₘ, and a data clock signal HCLK. The data control signals CONT2 may further include an inversion control signal RVS for reversing the polarity of the data voltages (with respect to the common voltage Vcom).

The data driver 500 receives the processed image signals DAT for a pixel row from the signal controller 600 and converts the processed image signals DAT into the analogue data voltages selected from the gray voltages supplied from the gray voltage generator 800 in response to the data control signals CONT2 from the signal controller 600.

In response to the gate control signals CONT1 from the signal controller 600, the gate driver 400 applies the gate-on voltage Von to the gate lines G₁-Gₙ, thereby turning on the switching elements Q connected to the gate lines G₁-Gₙ.

The data driver 500 applies the data voltages to corresponding data lines D₁-Dₘ for a turn-on time of the switching elements Q (which is called “one horizontal period” or “1H” and equals one period of the horizontal synchronization signal Hsync, the data enable signal DE, and the gate clock signal CPV). The data voltages are in turn supplied to corresponding pixels via the turned-on switching elements Q.

The difference between the data voltage and the common voltage Vcom applied to a pixel is expressed as the charged voltage of the LC capacitor C_{LC}, i.e., a pixel voltage. The liquid crystal molecules have orientations depending on the magnitude of the pixel voltage, and the orientations determine a polarization of light passing through the LC capacitor C_{LC}. The polarizers convert light polarization into light transmittance.

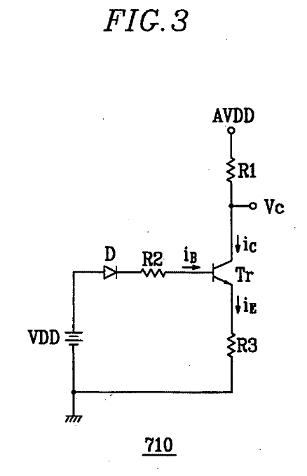

The drivers of the display device of FIG. 1 will be now described in greater detail with reference to FIGS. 3 to 5.

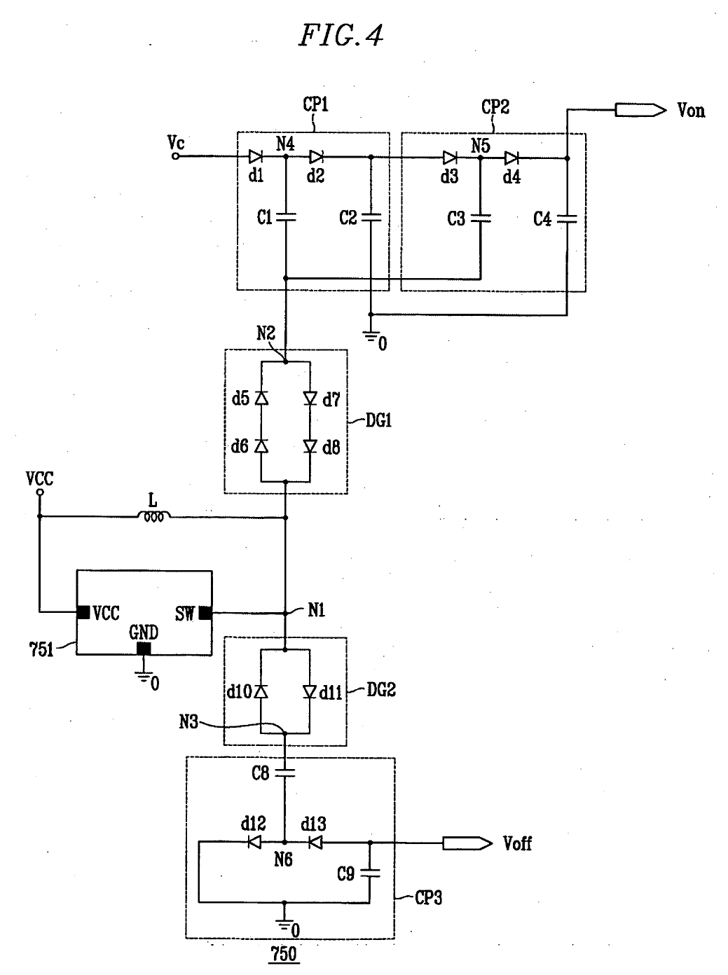

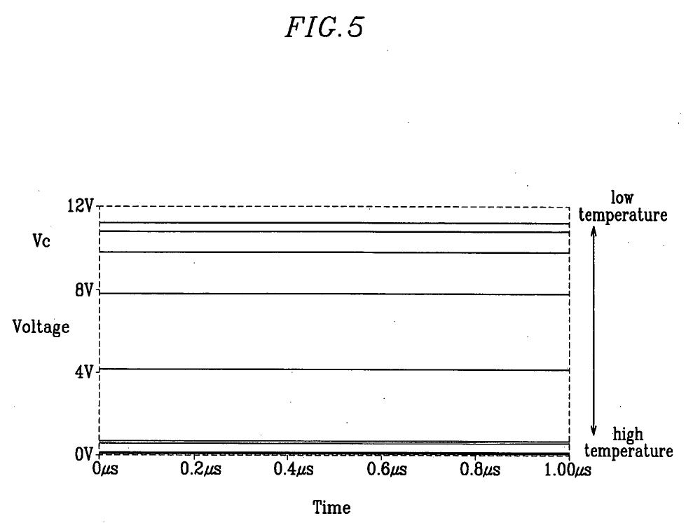

FIG. 3 is a circuit diagram showing an example of the controller shown in FIG. 1, FIG. 4 is a circuit diagram showing an example of the gate signal generator shown in FIG. 1, and FIG. 5 is a graphical view showing intensity of a control voltage according to temperature.

Referring to FIG. 3, the controller 710 includes a plurality of resistors R1-R3, a transistor Tr to which one end of each of the resistors R1-R3 is electrically connected, a diode D with one end electrically connected to the other end of the resistors R2, and a power supply VDD electrically connected to the other end of the diode D. The driving voltage AVDD transmitted from the driving voltage generator 700 is input to the other end of the resistors R1.

Here, the transistor Tr is an NPN type of BJT (bipolar junction transistor), and has three terminals: a base, an emitter, and a collector. Alternatively, the transistor Tr may be a PNP type of BJT or an MOS transistor.

Base, emitter, and collector currents i_{B}, i_{E}, and i_{C} flowing through the three terminals are defined by Equation 1.
i_{C}=G·i_{B} (Equation 1)

where G is a gain of amplification.

The power supply voltage VDD can be represented by the following Equation 2 by taking into consideration a threshold voltage V_{D} across the diode D.
VDD=V_{D}+i_{B}·R2 (Equation 2)

By rearranging Equation 2, the base current i_{B} is represented by the following Equation 3.
i_{B}=(VDD−VD)/R2 (Equation 3)

The control voltage Vc is represented by the following Equation 4.
Vc=AVDD−i_{C}·R1 (Equation 4)

By substituting Equation 3 to Equation 1, the collector current i_{C} is represented by the following Equation 5.
i_{C}=G(VDD−V_{D})/R2 (Equation 5)

By substituting Equation 5 to Equation 4, the control voltage Vc is represented by the following Equation 6.
Vc=AVDD−G˜R1(VDD−V_{D})/R2 (Equation 6)

The diode D is also a semiconductor device, and its threshold voltage V_{D} varies depending on temperature. As the temperature decreases, the threshold voltage V_{D} increases. Generally, the threshold value V_{D} is known to be about 2 mV/° C.

In a case where the temperature decreases, the threshold voltage V_{D} of the diode D increases, so the control voltage Vc increases as represented by Equation 6 and FIG. 5.

Assuming that the power supply voltage VDD is the threshold voltage V_{D} of the diode D (i.e., 0.7 V at room temperature), the control voltage Vc at room temperature is equal to the driving voltage AVDD. As the temperature decreases below room temperature, the threshold voltage V_{D} increases, so the control voltage Vc is higher than the driving voltage AVDD. As the temperature increases, the threshold voltage VD decreases, so the control voltage Vc is lower than the driving voltage AVDD. Alternatively, the power supply voltage VDD may have other values, and the reference temperature may be selected from temperature that is different from room temperature.

Next, the control voltage Vc is input to the gate signal generator 750 shown in FIG. 4.

As shown in FIG. 4, the driving voltage generator 750 comprises a pulse voltage generator 751, first and second diode units DG1 and DG2 electrically connected in series with the pulse voltage generator 751, and first, second, and third charge pump circuits CP1, CP2, and CP3, and an inductor L. The pulse voltage generator 751 is generally implemented in the form of an integrated circuit. The pulse voltage generator 751 comprises a Vcc terminal VCC, a ground voltage terminal GND, and a switching terminal SW. The Vcc terminal receives a predetermined voltage Vcc, such as, but not limited to, 3.3 V; the ground voltage terminal GND receives a ground voltage, or 0V; and the switching terminal SW is electrically connected to the seconde node N2.

The first diode unit DG1 comprises a fifth diode d5, a sixth diode d6, a seventh diode d7, and an eighth diode d8. The fifth and sixth diodes d5, d6 are serially, electrically connected to each other. In other words, the anode of the fifth diode d5 and the cathode of the fifth diode d6 are electrically connected together. And the cathode of the fifth diode d5 is electrically connected to the second node N2 and the anode of the fifth diode d6 is electrically connected to the first node N1. The cathode of the seventh diode d7 and the anode of the eighth diode d8 are electrically connected together. And the anode of the seventh diode d7 is electrically connected to the second node N2 and the cathode of the eighth diode d8 is electrically connected to the first node N1.

The second diode unit DG2 comprises a tenth diode d10 and an eleventh diode d11. The anode of the tenth diode d10 is electrically connected to the third node N3 and the cathode of the tenth diode d10 is electrically connected to the first node N1. The anode of the eleventh diode d11 is electrically connected to the first node N1 and the cathode of the eleventh diode d11 is electrically connected to the third node N3.

Each of the first, second, and third charge pump circuits CP1, CP2, and CP3 includes two diodes and two capacitors.

The charge pump circuit CP1 comprises a first diode d1, a second diode d2, a first capacitor C1, and a second capacitor C2. The anode of the first diode d1 receives the control voltage Vc and the cathode of the first diode d1 is electrically connected to a fourth node N4. The anode of the second diode d2 is electrically connected to the fourth node N4 and the cathode of the second diode d2 is electrically connected to one end of the second capacitor C2. One end of the first capacitor C1 is electrically connected to the fourth node N4 and the other end is electrically connected to the second node N2. One end of the second capacitor C2 is electrically connected to the cathode of the second diode d2 and the other end is electrically connected to a ground voltage.

The charge pump circuit CP2 comprises a third diode d3, a fourth diode d4, a third capacitor C3, and a fourth capacitor C4. The anode of the third diode d3 is electrically connected to one end of the second capacitor C2 and the cathode is electrically connected to a fifth node N5. One end of the third capacitor C3 is electrically connected to the fifth node N5 and the other end is electrically connected to the second node N2. The anode of the fourth diode d4 is electrically connected to the fifth node N5 and the cathode of the fourth diode d4 is electrically connected to one end of the fourth capacitor C4. One end of the fourth capacitor C4 is electrically connected to an output terminal outputting a Von and the other end of the fourth capacitor C4 is electrically connected to the ground voltage.

The charge pump circuit CP3 comprises a twelfth diode d12, a thirteen diode d13, an eighth capacitor C8, and a ninth capacitor C9. The anode of the twelfth diode d12 is electrically connected to a sixth node N6 and the cathode of the twelfth diode d12 is electrically connected to the ground voltage. The anode of the thirteenth diode d13 is electrically connected to the sixth node N6 and the cathode of the thirteenth diode d13 is electrically connected to the ninth capacitor C9. One end of the eighth capacitor C8 is electrically connected to the third node N3 and the other end is electrically connected to the sixth node N6. One end of the ninth capacitor C9 is electrically connected to an output terminal outputting Voff and the other is electrically connected to the ground voltage.

One end of the inductor L is electrically connected to the first node N1 and the other end receives the voltage Vcc.

The operation of the gate signal generator 750 will be now described in detail with reference to FIG. 4.

Assuming that each of the first to eighth diodes d1-d8 and the tenth to thirteenth d10-d13 has a threshold voltage of 0.7 Vand the control voltage Vc has 10V, the pulse voltage generator 751 periodically generates a low level of 0V and a high level of 10V in exemplary embodiments of the present invention.

If the pulse voltage generator 751 applies a voltage of 0 V to the node N1, the voltage increases by 1.4 V through the seventh and eighth diodes d7 and d8 in the backward direction. Therefore, a voltage of the node N2 becomes 1.4 V.

On the other hand, since the control voltage Vc is 10 V, the voltage drops by 0.7 V through the first diode d1, so that a voltage of the node N4 becomes 9.3 V. As a result, a voltage across the first capacitor C1 becomes 7.9 V.

Next, if a voltage of 10 V is applied to the first node N1, a forward current flows through the fifth and sixth diodes d5, d6, and the voltage of the second node N2 changes to 8.6 V. Accordingly, the voltage of the fourth node N4 becomes 16.5 V, which is a sum of the voltage across the first capacitor C1 and the node voltage V_{N2}. Then, the voltage drops by 1.4 V through the second and third diodes d2 and d3, so that a voltage of the fifth node N5 becomes 15.1 V.

Subsequently, if the voltage of the first node N1 returns to 0 V, the voltage of the second node N2 changes to 1.4 V and the voltage across the third capacitor C3 becomes 13.7 V, which is the difference between 15.1 V and 1.4 V.

In the same manner, if the voltage of the second node N2 changes to 8.6 V again, the voltage of the fifth node N5 becomes 22.3 V, which is a sum of the voltage across the third capacitor C3 and the voltage of the second node N2. As a result, the voltage through the fourth diode d4 is output as the gate-on voltage Von of 21.6 V.

After that, the diode d4 may be turned on only if the voltage of the anode of the diode d4, i.e. the voltage of the fifth node N5, is higher than the gate-on voltage Von. If the voltage of the cathode of the fourth diode d4, i.e. the gate-on voltage Von, is higher than the voltage of the fifth node N5, the fourth diode d4 is turned off. Therefore, the fourth capacitor C4 is in a floating state, so that a voltage of 21.6 V across the fourth capacitor C4 can be continuously output.

Herein, since the operation for outputting the gate-on voltage Von in the gate signal generator 750 is an operation of a linear circuit, if the control voltage Vc changes, then the gate-on voltage Von changes by the same amount as the control voltage Vc. For example, if the control voltage Vc changes to 12 V, the output also increases by 2 V to 23.6 V.

The operation for generating the gate-off voltage Voff will be now described in detail with reference to FIG. 4.

If the voltage of 10 V is applied to the first node N1, an electric current flows through the eleventh diode d11, the eighth capacitor C8, and the twelfth diode d12 to the ground voltage. Therefore, the voltage of the third node N3, i.e. V_{N3}, becomes 9.3 V and the voltage of the sixth node N6 becomes 0.7 V. At this time, the voltage across the eighth capacitor C8 becomes 8.6 V, which is the difference between the voltages of the third and sixth nodes N3 and N6.

Subsequently, if the voltage of the first node N1 becomes 0V, the electric current flows in the reverse direction from the ground voltage to the ninth capacitor C9 the thirteenth diode d13, the eighth capacitor C8, and the tenth diode d10. Therefore, the voltage of the third node N3 changes from 9.3 V to 0.7 V. Since the voltage of the third node N3 is a sum of the voltage across the eighth capacitor C8 and the voltage of the sixth node N6, the voltage of the sixth node N6 becomes −7.9 V and the voltage of the gate-off voltage output terminal Voff becomes −7.2 V, i.e. a sum of −7.9 V and the threshold voltage, for example, 0.7V, of the thirteenth diode d13.

Next, if the voltage of the first node N1 returns to 10 V, the thirteenth diode d13 is turned off and the ninth capacitor C9 is in a floating state. Therefore, the voltage of −7.2 V is continuously output, and if the voltage of the first node N1 becomes 0 V, the aforementioned operations repeat to output −7.2 V.

As such, the control voltage Vc changes only the level of the gate-on voltage Von and has no effect on the level of the gate-off voltage Voff.

More specifically, unlike in the conventional technique where the driving voltage AVDD is designed to depend on a change in temperature, in the present invention, only the gate-on voltage Von which is necessary to turn on the transistors (not shown) constituting the gate driver 400 (see FIG. 1) and the switching devices of the pixels PX is designed to change. According to the exemplary embodiments of the present invention, since only the gate-on voltage Von is designed to change, problems of deteriorating image quality characteristics, increasing power consumption, increasing operating temperature of the drivers, and shortening of lifespan of a product due to the change in the driving voltage AVDD can be solved.

Although the exemplary embodiments and the modified examples of the present invention have been described, the present invention is not limited to the embodiments and examples, but may be modified in various forms without departing from the scope of the appended claims, the detailed description, and the accompanying drawings of the present invention. Therefore, it is natural that such modifications belong to the scope of the present invention.

What is claimed is:

1. A driving circuit for a display device having a plurality of pixels each including a switching device, the driving circuit comprising:
a driving voltage generator operable to generate a first voltage;
a controller operable to receive the first voltage and to generate a second voltage according to an ambient temperature; and
a gate signal generator operable to generate a third voltage based on the second voltage.

2. The driving circuit of claim 1, wherein the second voltage is higher than the first voltage if the ambient temperature is lower than a predetermined temperature,
wherein and the second voltage is lower than the first voltage if the ambient temperature is higher than the predetermined temperature.

3. The driving circuit of claim 2, wherein the third voltage turns on the switching device.

4. The driving circuit of claim 3, wherein the gate signal generator further generates a fourth voltage based on the second voltage and the fourth voltage turns off the switching device.

5. The driving circuit of claim 4, wherein the gate signal generator comprises:
a first charge pump circuit comprising a first diode, a second diode, a first capacitor, and a second capacitor, the anode of the first diode receiving the second voltage and the cathode of the first diode electrically connected to a fourth node; one end of the first capacitor electrically connected to the fourth node and the other end electrically connected to a second node; the anode of the second diode electrically connected to the fourth node and the cathode of the second diode electrically connected to one end of the second capacitor; and the one end of the second capacitor electrically connected to the cathode of the second diode and the other electrically connected to a ground voltage;
a second charge pump circuit comprising a third diode, a fourth diode, a third capacitor, and a fourth capacitor, the anode of the third diode electrically connected to the one end of the second capacitor and the cathode of the third diode electrically connected to a fifth node; one end of the third capacitor electrically connected to the fifth node and the other electrically connected to the second node; the anode of the fourth diode electrically connected to the fifth node and the cathode of the fourth diode electrically connected to a Von output terminal and one end of the fourth capacitor; and the one end of the fourth capacitor electrically connected to the anode of the fourth diode and the other end electrically connected to the ground voltage;
a first diode unit comprising fifth, sixth, seventh, and eighth diodes, the anode of the fifth diode electrically connected to the second node and the cathode of the fifth diode electrically connected to the cathode of the sixth diode; the anode of the sixth diode electrically connected to the first node and the cathode of the sixth diode electrically connected to the anode of the fifth diode; the anode of the seventh diode electrically connected to the second node and the cathode of the seventh diode electrically connected to the anode of the eighth diode; and the anode of the eighth diode electrically connected to the cathode of the seventh diode and the cathode of the eighth diode electrically connected to the first node;
a pulse voltage generator electrically connected to the first node and receiving the second voltage; and
an inductor electrically connected to the first node and receiving the second voltage.

6. The driving circuit of claim 5, wherein the gate signal generator further comprises:
a third charge pump circuit comprising a twelfth diode, a thirteenth diode, an eighth capacitor, and a ninth capacitor, one end of the eighth capacitor electrically connected to a third node and the other electrically connected to a sixth node; the anode of the twelfth diode electrically connected to the sixth node and the cathode of the twelfth diode electrically connected to the ground voltage; the anode of the thirteenth diode electrically connected to a Voff terminal and the cathode of the thirteenth diode electrically connected to the sixth node; and one end of the ninth capacitor electrically connected to the anode of the thirteenth diode and the other electrically connected to the ground voltage; and
a second diode unit comprising tenth and eleventh diodes, the anode of the tenth diode electrically connected to the third node and the cathode of the tenth diode electrically connected to the first node; and the anode of the eleventh diode electrically connected to the first node and the cathode of the eleventh diode electrically connected to the third node.

7. The driving circuit of claim 6, wherein the controller comprises:
a transistor having first, second, and third terminals;
a first resistor disposed between the first terminal of the transistor and the first voltage;
a power supply voltage, a diode, and a second resistor electrically connected in series between a ground voltage and the second terminal of the transistor; and
a third resistor disposed between the third terminal of the transistor and the ground voltage.

8. The driving circuit of claim 7, wherein the transistor is a BJT (bipolar junction transistor).

9. A display device having a plurality of pixels each including a switching device, the display device comprising:
a driving voltage generator operable to generate a first voltage;
a controller operable to receive the first voltage and to generate a second voltage according to an ambient temperature;
a gate signal generator operable to generate a third voltage based on the second voltage;
a signal controller operable to generate control signals and image data signals;
a data driver operable to receive the control signals and the image data signals;
a gate driver operable to receive the third voltage and to apply the third voltage to the switching device; and
a gray voltage generator operable to generate a plurality of gray voltages based on the first voltage.

10. The display device of claim 9, wherein the second voltage is higher than the first voltage if the ambient temperature is lower than a predetermined temperature, and
wherein the second voltage is lower than the first voltage if the ambient temperature is higher than the predetermined temperature.
